(19) United States
(12) Patent Application Publication
(10) Pub. No.: US 2026/0170955 A1
(43) Pub. Date: Jun. 18, 2026

(54) Method for Transferring Longitudinal and/or Lateral Guidance of a Vehicle to an at Least Partially Automated Driving Function, Computing Device, Computer-Readable (Storage) Medium, and System for Transfer

(71) Applicant: Bayerische Motoren Werke Aktiengesellschaft, Muenchen (DE)

(72) Inventor: Michael STROEBEL, Groebenzell (DE)

(21) Appl. No.: 18/862,692

(22) PCT Filed: Apr. 28, 2023
(86) PCT No.: PCT/EP2023/061232

§ 371 Date: Nov. 4, 2024

(30) Foreign Application Priority Data
May 27, 2022 (DE) 10 2022 113 415.6

(51) Int. Cl. G08G 1/0967; B60W 50/14; B60W 60/00; H04W 4/48

(52) U.S. Cl. CPC G08G 1/096725; B60W 50/14; B60W 60/0051; H04W 4/48; B60W 2050/146

(57) ABSTRACT

The invention relates to a method for transferring longitudinal and/or lateral guidance of a vehicle to an at least partially automated driving function of the vehicle. In one form, a method comprises receiving a transfer request signal which describes a transfer request to a driver of the vehicle for transferring the longitudinal and/or lateral guidance of the vehicle to the at least partially automated driving function of the vehicle. The method may also comprise outputting an alert signal, wherein the alert signal can be used to alert the driver to the transfer request for transferring the longitudinal and/or lateral guidance of the vehicle to the at least partially automated driving function. Finally, the method may also comprise takeover of the longitudinal and/or lateral guidance of the vehicle by the at least partially automated driving function of the vehicle.

### BACKGROUND AND SUMMARY

The present invention relates to a method for transferring longitudinal and/or lateral guidance of a vehicle to an at least partially automated driving function of the vehicle. In addition, the present invention relates to a computing device. Furthermore, the present invention relates to a computer-readable (storage) medium. Finally, the present invention relates to a system for transferring longitudinal and/or lateral guidance of a vehicle to an at least partially automated driving function of the vehicle.

Assistance systems for vehicles can currently take over a variety of tasks of the longitudinal and/or lateral guidance of the vehicle. For example, assistance systems exist which control the vehicle in a (fully) automated manner up to a specified maximum speed. Moreover, the situation comprehension of vehicles or the corresponding computing devices is also always becoming better. Manifold possibilities result therefrom for offering the transfer of the longitudinal and/or lateral guidance of the vehicle to an assistance system of the vehicle or to an at least partially automated driving function to a driver of the vehicle situationally and proactively. It is thus possible, for example, to give the driver the suggestion in a congestion situation that he transfer the driving task, thus the longitudinal and/or lateral guidance of the vehicle, to a corresponding assistant system or to a corresponding at least partially automated driving function of the vehicle.

It is the object of the present invention to disclose a solution for how the transfer of longitudinal and/or lateral control of the vehicle to an automated driving function of the vehicle can be situationally designed and improved.

This object is achieved according to the invention by a method, by a computing device, by a computer-readable (storage) medium, and by a system having the features according to the independent claims. Advantageous refinements of the present invention are specified in the dependent claims.

The concept of “at least partially automated” driving or maneuvering comprises automated driving with an arbitrary degree of automation. Exemplary degrees of automation are assisted, partially automated, highly automated, fully automated, and autonomous driving (each with increasing degree of automation).

One form of a method according to the invention for transferring longitudinal and/or lateral guidance of a vehicle to an at least partially automated driving function of the vehicle comprises receiving a transfer request signal, which describes a transfer request to a driver of the vehicle to transfer the longitudinal and/or lateral guidance of the vehicle to the at least partially automated driving function of the vehicle. Moreover, the method may comprise outputting a notification signal, wherein the driver can be notified on the basis of the notification signal of the transfer request to transfer the longitudinal and/or lateral guidance to the at least partially automated driving function. Finally, the method according to the invention may comprise taking over of the longitudinal and/or lateral guidance of the vehicle by the at least partially automated driving function of the vehicle. In this case, the notification signal is received as a result of an instruction originating from a further road user in the surroundings of the vehicle. In addition, the at least partially automated driving function can take over the longitudinal and/or lateral guidance of the vehicle in such a way that the vehicle executes the instruction of the further road user in an at least partially automated manner.

Forms of a method according to the invention are thus used to transfer the longitudinal and/or lateral guidance of the vehicle to the at least partially automated driving function of the vehicle as a result of an instruction originating from the further road user. For example, the method according to the invention can thus be used to transfer the longitudinal and/or lateral guidance of the vehicle when an emergency vehicle (such as a police vehicle) as the further road user instructs the driver to pull over. The at least partially automated driving function can thereupon take over the longitudinal and/or lateral guidance of the vehicle until the vehicle has complied with the instruction. The at least partially automated driving function can thus take over the longitudinal and/or lateral guidance of the vehicle until the vehicle—in consideration of corresponding traffic regulations and in consideration of possible safety aspects—has pulled over.

Forms of the method can be carried out, for example, by means of a computing device. The computing device can be formed, for example, by at least one electronic control unit of the vehicle. The computing device can have one or more programmable processors. Moreover, the computing device can have a (storage) medium, on which a computer program is stored. In order to execute corresponding method steps, the computer program can be executed on the computing device.

Initially, a transfer request signal can be received for this purpose. The transfer request signal can be provided, for example, by the further road user. The further road user can be, for example, a police vehicle, an unmarked vehicle of the police, a fire department vehicle, an ambulance, a towing service, a military vehicle, a diplomatic vehicle, or the like. The further road user can transmit the transfer request signal to the vehicle, for example, by means of a so-called vehicle-to-vehicle communication. The further road user can thus request that the vehicle or the driver of the vehicle transfer the longitudinal and/or lateral guidance of the vehicle to the at least partially automated driving function so that the at least partially automated driving function complies with the instruction of the further road user.

However, it is also conceivable that the transfer request signal is provided by a sensor of the vehicle itself. For example, the transfer request signal can be provided by a camera of the vehicle when the camera of the vehicle recognizes that one of the above-mentioned emergency vehicles in the surroundings of the vehicle issues instructions to the driver of the vehicle.

If such a transfer request signal is received, a notification signal can be output. The driver of the vehicle can be notified, for example, by means of a display device of the transfer request on the basis of the notification signal. It can thus be displayed to the driver of the vehicle by means of the notification signal that a transfer request of the further road user to transfer the longitudinal and/or lateral guidance to the at least partially automated driving function is present.

The at least partially automated driving function of the vehicle can thereupon take over the longitudinal and/or lateral guidance of the vehicle. The vehicle can thus comply with the instruction of the further road user in an at least partially automated manner in the scope of the at least partially automated driving function of the vehicle.

Manifold advantages result due to the method according to the invention. For example, language barriers and/or comprehension problems can thus be bypassed. If, for example, the instruction of the further road user takes place in a language which the driver of the vehicle does not understand, the driver can be notified in a language predetermined by him of the instruction of the further road user by means of the notification signal. Additionally or alternatively, it can be ensured by means of the method according to the invention that the vehicle complies with the instructions of an emergency vehicle or the further road user. Moreover, by means of the method according to the invention, an emergency stopping maneuver or the like can also be performed by the further road user in case of a refusal by the driver of the vehicle.

In general, a variety of instructions of the further road user are possible. As already mentioned at the outset, this can be, for example, the instruction to pull over. The instruction to form an emergency lane, to clear a specific lane, is also conceivable.

In one advantageous embodiment of the method according to the invention, the transfer request signal is received at least indirectly from the further road user in the surroundings of the vehicle. As already indicated, the further road user can transmit the transfer request signal to the vehicle, for example, via a so-called vehicle-to-vehicle communication. A communication via Internet (possibly also via a backend) is likewise conceivable.

An unmarked vehicle of the police as the further road user can issue an instruction, for example, to the driver of the vehicle. For example, it is conceivable that the unmarked emergency vehicle drives behind the vehicle and requests or instructs the driver of the vehicle to pull over. If the driver of the vehicle does not comply with the instruction, the unmarked emergency vehicle can transmit the transfer request signal by means of vehicle-to-vehicle communication to the vehicle. A notification signal can thereupon be output. It can be signaled to the driver by means of the notification signal that he is instructed to transfer the longitudinal and/or lateral guidance to the at least partially automated driving function. The longitudinal and/or lateral guidance of the vehicle can thereupon be transferred to the at least partially automated driving function of the vehicle with or without the consent of the driver. The vehicle can thus comply with the instruction of the unmarked emergency vehicle and pullover.

It is also advantageous here if the transfer request signal received from the further road user in the surroundings of the vehicle is checked for plausibility with the aid of first sensor data of a first surroundings sensor of the vehicle before the output of the notification signal. In order to prevent a possible misuse, the transfer request signal can thus be checked for plausibility. If an unmarked emergency vehicle outputs a transfer request signal, for example, it can be checked by means of a first surroundings sensor of the vehicle, such as a camera, whether a legitimate instruction of a corresponding further road user exists. It is thus possible to prevent the transfer request signal from being able to be output by arbitrary further road users.

A further advantageous embodiment provides that the transfer request signal received from the further road user in the surroundings of the vehicle is received indirectly via a plausibility check server. In other words, the transfer request signal can thus be transmitted from the further road user to a plausibility check server, which then passes on the transfer request signal to the vehicle, which can thus receive the transfer request signal. The communication via the plausibility check server can in particular take place in encrypted form here. A possibly abusive transfer of the longitudinal and/or lateral guidance of the vehicle to the at least partially automated driving function of the vehicle can thus be prevented.

It can be advantageous in this context if the further road user transmits at least one plausibility check variable to the plausibility check server and the transfer request signal additionally describes a result of a plausibility check. In order to ensure that the correct vehicle is instructed to pull over, for example, by the further road user, it can thus be provided that the further road user transmits at least one plausibility check variable to the plausibility check server. For example, a vehicle model, a license plate number of the vehicle, and/or an ego position of the further road user can be used as the at least one plausibility check variable. It can thus be checked by means of the plausibility check whether, for example, the license plate number matches with the reported vehicle model. Additionally or alternatively, it can be checked whether the ego position of the further road user is in the surroundings of the vehicle at all. In other words, it can thus be insured by a position comparison that no remote instructions can be carried out. Misuse and human errors can thus be reduced or prevented.

A further advantageous embodiment of the method according to the invention provides that the further road user is identified in second sensor data of a second surroundings sensor of the vehicle and the further road user is characterized as an emergency vehicle, which issues the instruction to the driver of the vehicle, and as a result of which the transfer request signal is received. In other words, the further road user can thus be identified by means of a camera as the second surroundings sensor. The further road user can be characterized here by means of the camera or corresponding methods of machine vision as an emergency vehicle which instructs the driver of the vehicle to follow, for example. The transfer request signal can thereupon be provided by the second surroundings sensor, thus the camera. The transfer request signal can thus be received. The advantage results therefrom that no additional communication devices or the like are necessary. Instead, the sensors of the vehicle can be used. Overall, a higher level of functional availability can thus be ensured, even in remote regions and emerging countries.

Moreover, it can be advantageous if the takeover of the longitudinal and/or lateral guidance of the vehicle by the at least partially automated driving function of the vehicle is restricted up to a standstill time. In particular, it can be advantageous on a freeway if the further road user instructs the driver of the vehicle, for example, to pull over. However, it can also be disadvantageous in certain situations if the takeover of the longitudinal and/or lateral guidance of the vehicle by the at least partially automated driving function of the vehicle is restricted up to a standstill time. Thus, for example, at a traffic signal or in dense stop and go traffic and when the further road user actually instructs the driver of the vehicle to follow, for example.

In other words, it can thus be advantageous in predetermined situations and/or in the event of predetermined instructions if the takeover of the longitudinal and/or lateral guidance of the vehicle by the at least partially automated driving function of the vehicle is restricted up to a standstill time. The standstill time can describe a time at which the vehicle is actually at a standstill. However, it can also be a time at which the vehicle does not reach a minimum velocity. In general, the standstill time can be a time at which the vehicle assumes or achieves a predetermined status.

A further advantageous embodiment of the method according to the invention provides that the takeover of the longitudinal and/or lateral guidance of the vehicle by the at least partially automated driving function of the vehicle is alternatively or additionally restricted to a predetermined period of time and/or a predetermined driving route. In other words, it can thus be ensured that a permanent transfer of the longitudinal and/or lateral guidance to the at least partially automated driving function does not take place. It can thus be ensured that actually only the instruction of the further road user is complied with.

It can be advantageous here if the predetermined period of time and/or the predetermined driving route is specified in the scope of the transfer request of the further road user. This is advantageous in particular if the vehicle is to follow the further road user for a longer period of time and/or a longer driving route. However, it is also conceivable in this case that the predetermined period of time and/or the predetermined driving route is restricted by corresponding maximum values.

A further advantageous embodiment provides that the takeover of the longitudinal and/or lateral guidance of the vehicle by the at least partially automated driving function of the vehicle takes place in dependence on a driver input, which is detected as a result of the notification signal and describes a consent of the driver to the takeover of the longitudinal and/or lateral guidance by the at least partially automated driving function of the vehicle.

A computing device according to the invention for a vehicle is configured to carry out a method according to the invention and the advantageous embodiments thereof. The computing device can be designed, for example, as an electronic control unit, which comprises one or more programmable processors.

A computer-readable (storage) medium according to the invention comprises commands which, upon the execution thereof by a computing device, prompt it to carry out a method according to the invention and advantageous embodiments thereof.

A system according to the invention for transferring a longitudinal and/or lateral guidance of a vehicle to an at least partially automated driving function of the vehicle comprises a computing device according to the invention and a display device, which is configured to notify a driver of the vehicle of a transfer request to transfer the longitudinal and/or lateral guidance to the at least partially automated driving function of the vehicle by means of a notification signal output by the computing device. The display device can be designed as a visual, haptic, and/or acoustic display device.

In addition, some forms of a system according to the invention can have a driver input device configured to detect a driver input. A driver input can describe a consent or refusal of the driver of the notification signal for the takeover of the longitudinal and/or lateral guidance by the at least partially automated driving function of the vehicle.

It can be advantageous if the system according to the invention has a receiver configured to receive a transfer request signal. The receiver can be advantageous in particular if the transfer request signal is received at least indirectly from a further road user in the surroundings of the vehicle.

A further aspect of the invention relates to a computer program comprising commands which, upon the execution of the program by a computing device, prompt it to carry out a method according to the invention and advantageous embodiments thereof. Furthermore, the invention relates to a vehicle comprising a system according to the invention. The vehicle can be designed in particular as a passenger vehicle or truck.

The preferred embodiments presented with respect to the method according to the invention and the advantages thereof apply accordingly to the computing device according to the invention, to the computer-readable (storage) medium according to the invention, and to the system according to the invention. Furthermore, the preferred embodiments presented with respect to the method according to the invention and the advantages thereof also apply to the computer program according to the invention and to the vehicle according to the invention.

Further features of the invention result from the claims, the figures, and the description of the figures. The features and combinations of features mentioned above in the description and the features and combinations of features mentioned hereinafter in the description of the figures and/or solely shown in the figures are usable not only in the respectively specified combination, but also in other combinations or alone, without departing from the scope of the invention.

### BRIEF DESCRIPTION OF THE DRAWINGS

The invention will now be explained in more detail on the basis of preferred exemplary embodiments and with reference to the appended drawings. In the figures:

FIG. 1 shows a schematic representation of a vehicle, comprising a computing device for carrying out a method for transferring longitudinal and/or lateral guidance of the vehicle,

FIG. 2 shows a flow chart comprising method steps of the method according to the invention for transferring longitudinal and/or lateral guidance of the vehicle, and

FIG. 3 shows a traffic situation in which the driver of the vehicle is instructed to follow by a police vehicle.

### DETAILED DESCRIPTION OF THE DRAWINGS

In the figures, identical or functionally-identical elements are provided with identical reference signs.

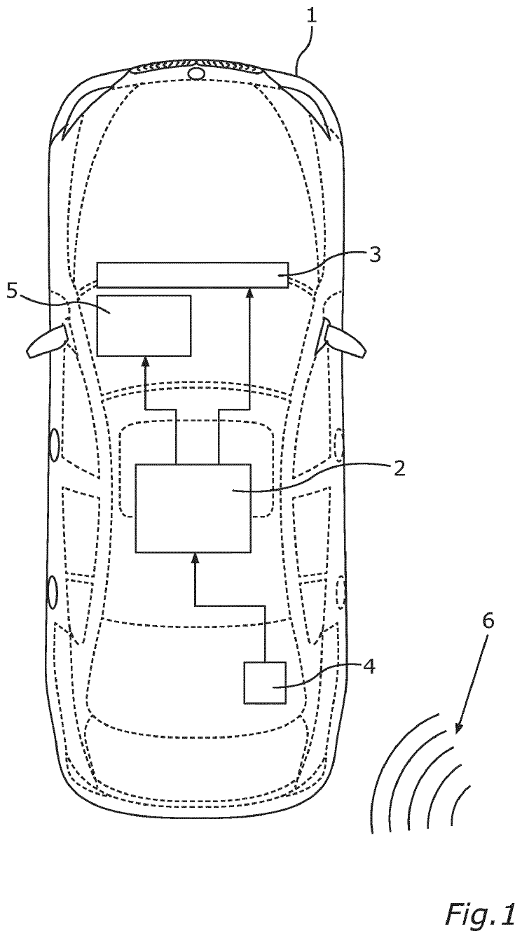

FIG. 1 shows a schematic representation of a vehicle 1, which comprises a computing device 2, a display device 3, a receiver 4, and a central control unit 5. The vehicle 1—as shown in FIG. 1—can be designed as a passenger vehicle. A transfer request signal 6 can be received by means of the receiver 4. The computing device 2 can thus receive the transfer request signal 6 from the receiver 4.

In the exemplary embodiment of FIG. 1, the transfer request signal 6 is received via radio. However, it is also conceivable that the transfer request signal 6 is received, for example, from a sensor of the vehicle 1 as a result of an object identification.

A notification signal can be output to the driver 13 of the vehicle 1 by means of the display device 3. The notification signal can notify the driver 13 of the vehicle 1 of the transfer request, which can be described by the transfer request signal 6. The longitudinal and/or lateral guidance of the vehicle 1 can then be transferred to the central control unit 5, which is configured to control the longitudinal and/or lateral guidance of the vehicle 1.

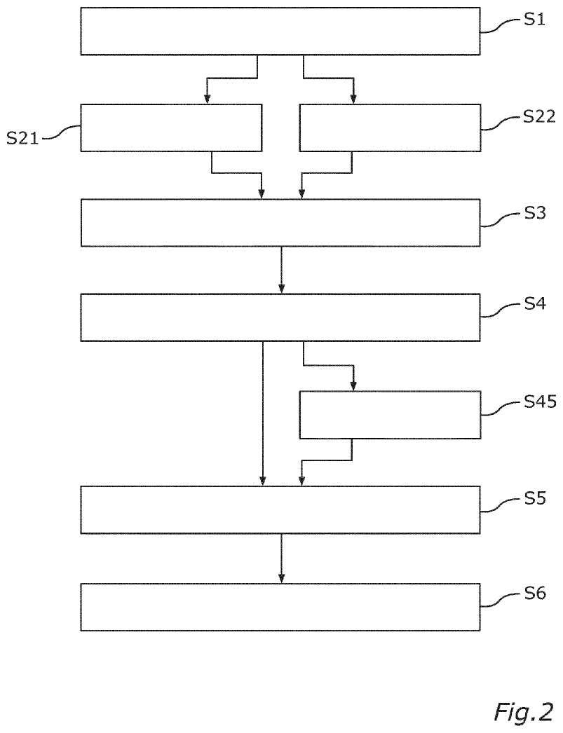

FIG. 2 shows a flow chart of the method according to the invention for transferring the longitudinal and/or lateral guidance of the vehicle 1 to the at least partially automated driving function of the vehicle 1, wherein the at least partially automated driving function of the vehicle 1 can be carried out, for example, by means of the central control unit 5.

In a step S1, the further road user 7, such as an emergency vehicle, requests that the driver of the vehicle 1 follow the further road user 7. For example, such a request can be produced by lettering in a display device 8 of the further road user 7. On the one hand, it is now possible that the further road user, in a step S21, at least indirectly provides a transfer request signal 6, for example by means of vehicle-to-vehicle communication. On the other hand, however, it is also conceivable that in a step S22, the transfer request signal 6 is provided by means of a camera 9 or a second surroundings sensor 9 which can be installed, for example, in the mount 10 of the rearview mirror 11 of the vehicle 1 behind a windshield.

In a step S3, the transfer request signal 6 can now be received. In a step S4, the notification signal can then be output to the driver 13 of the vehicle 1. In an optional step S45, a driver input of the vehicle 13 of the vehicle 1 can be detected. Such a driver input can be, for example, a consent to transfer the longitudinal and/or lateral guidance of the vehicle 1 to the at least partially automated driving function of the vehicle 1. Such a consent can be granted, for example, by pressing a button on the steering wheel of the vehicle 1, a speech input, or the like.

In a step S5, the transfer of the longitudinal and/or lateral guidance of the vehicle 1 to the at least partially automated driving function of the vehicle 1 can now take place. In a step S6, the longitudinal and/or lateral guidance of the vehicle 1 can finally be transferred back to the driver of the vehicle 1, after the request of the further road user 7 has been complied with.

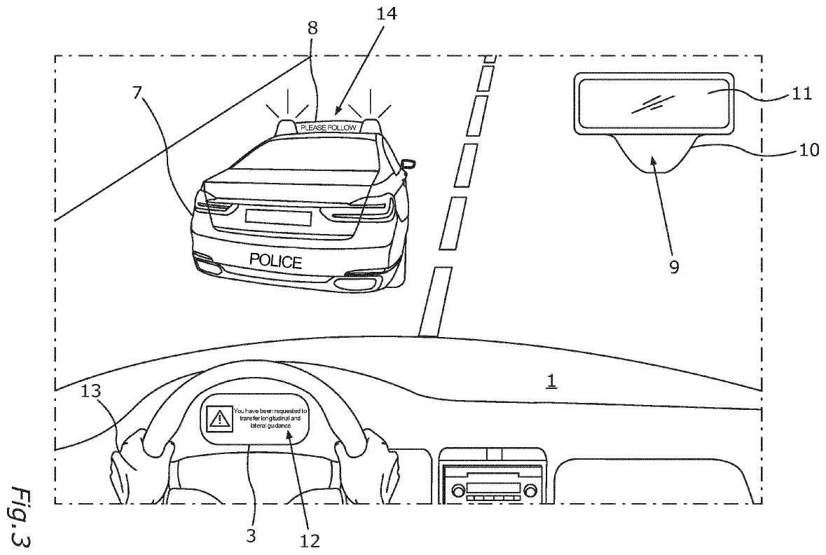

FIG. 3 shows a traffic situation, in which the driver of the vehicle 1 is instructed to follow by a further road user 7, shown here as a police vehicle. The instruction 14 takes place by means of a display device 8 of the further road user 7. A notification 12 can thereupon be output to the driver 13 of the vehicle 1 by means of the display device 3—shown here in an instrument cluster of the vehicle 1.

The further road user 7 can be identified in second sensor data and characterized by means of a second surroundings sensor 9, shown here as a camera 9, which can be installed in the mount 10 of the rearview mirror 11 of the vehicle 1 behind the windshield. In another embodiment, however, the camera 9 can also be used as a first surroundings sensor, in order to check for plausibility a transfer request signal 6, which is provided at least indirectly by the further road user 7.

1-13. (canceled)

14. A method for transferring at least one of longitudinal or lateral guidance of a vehicle to an at least partially automated driving function of the vehicle, the method comprising:
receiving a transfer request signal, the transfer request signal describing a transfer request to a driver of the vehicle to transfer the at least one of longitudinal or lateral guidance of the vehicle to the at least partially automated driving function of the vehicle;
outputting a notification signal, wherein the driver is notified on the basis of the notification signal of the transfer request to transfer the at least one of longitudinal or lateral guidance to the at least partially automated driving function; and
taking over of the at least one of longitudinal or lateral guidance of the vehicle by the at least partially automated driving function of the vehicle;
wherein the notification signal is received as a result of an instruction originating from a further road user in surroundings of the vehicle; and
wherein the at least partially automated driving function takes over the at least one of longitudinal or lateral guidance of the vehicle in such a way that the vehicle executes the instruction of the further road user in an at least partially automated manner.

15. The method according to claim 15, wherein:
the transfer request signal provided by the further road user is at least indirectly received from the further road user.

16. The method according to claim 15, wherein:
the transfer request signal received from the further road user in the surroundings of the vehicle is checked for plausibility with the aid of first sensor data of a first surroundings sensor of the vehicle before the output of the notification signal.

17. The method according to claim 15, wherein:
the transfer request signal received from the further road user in the surroundings of the vehicle is received indirectly via a plausibility check server.

18. The method according to claim 17, wherein:
the further road user transmits at least one plausibility check variable to the plausibility check server and the transfer request signal additionally describes a result of a plausibility check.

19. The method according to claim 14, wherein:
the further road user is identified in second sensor data of a second surroundings sensor of the vehicle and the further road user is characterized as an emergency vehicle, which issues the instruction to the driver of the vehicle and as a result of which the transfer request signal is received.

20. The method according to claim 14, wherein:
the takeover of the at least one of longitudinal or lateral guidance of the vehicle by the at least partially automated driving function of the vehicle is restricted up to a standstill time.

21. The method according to claim 14, wherein:
the takeover of the at least one of longitudinal or lateral guidance of the vehicle by the at least partially automated driving function of the vehicle is alternatively or additionally restricted to at least one of a predetermined period of time or a predetermined driving route.

22. The method according to claim 21, wherein:
the at least one of the predetermined period of time or the predetermined driving route is specified in the scope of the transfer request of the further road user.

23. The method according to claim 14, wherein:
the takeover of the at least one of longitudinal or lateral guidance of the vehicle by the at least partially automated driving function of the vehicle takes place in dependence on a driver input which is detected as a result of the notification signal and describes a consent of the driver to the takeover of the at least one of longitudinal or lateral guidance by the at least partially automated driving function of the vehicle.

24. A computing device for a vehicle, which is configured to carry out a method according to claim 14.

25. A computer-readable storage medium comprising commands which, upon the execution thereof by a computing device, direct the computing device to carry out a method according claim 14.

26. A system for transferring at least one of longitudinal or lateral guidance of a vehicle to an at least partially automated driving function of the vehicle, comprising:
a computing device according to claim 24; and
a display device, which is configured to notify a driver of the vehicle of a transfer request to transfer the at least one of longitudinal or lateral guidance to the at least partially automated driving function of the vehicle by means of a notification signal output by the computing device.
